(19) United States
(12) Patent Application Publication
(10) Pub. No.: US 2003/0037953 A1
(43) Pub. Date: Feb. 27, 2003

(54) Cable management sytem and apparatus

(75) Inventors: Scott A. Sarkinen, Mounds View, MN (US); Scott A. Davidson, Savage, MN (US); Joseph A. Halfen, Woodbury, MN (US); Micah T. Somers, Minneapolis, MN (US)

Correspondence Address: Kagan Binder, PLLC, Suite 200, 221 Main Street North, Stillwater, MN, 55082-5021, US

(73) Assignee: Terago Communications, Inc.

(21) Appl. No.: 09/935,066

(22) Filed: Aug. 22, 2001

(51) Int. Cl. H02G 3/00

(52) U.S. Cl. 174/72 R

(57) ABSTRACT

A cable management apparatus guides and supports cables when mounted as part of an electronics assembly. Preferably, cables enter the electronics assembly through the rear of the electronics assembly and through each side of the electronics assembly. Cables entering the electronics assembly are guided to the electronic components within the electronics assembly. Cables are organized such that individual cables or groups of cable may be associated with specific electronic components within the electronics assembly. Cables or groups of cables associated with specific electronic components within the electronics assembly may be accessed individually while handling a large bundle of cables. In one embodiment of the present invention fiber optic cables are supported such that a minimum bend radius is maintained. Thus, in accordance with one specific aspect of the present invention, fiber optic cables may be supported and organized as part of an electronics assembly.

### TECHNICAL FIELD

The present invention relates to an apparatus for the routing and management of wires and cables to and from an equipment enclosure or cabinet. More particularly, this invention pertains to a wire and cable routing and management apparatus, which allows for easy access to individual cables while handling a large bundle.

### BACKGROUND OF THE INVENTION

In the telecommunications industry, routing of cables from one piece of equipment to another is commonplace. Communication services providers, such as internet, telecommunications, and cable television service providers, generally interconnect a large number of electronic components for signal transmission and reception. Such components may include, for example, switching and routing cards, and any other devices for performing signal operations.

Typically, the electronic equipment includes modules, for example, switching and routing modules that are mounted within a chassis. Generally, cables enter the chassis and are coupled to such modules. Typically, after being coupled to modules within the chassis, cables exit the chassis. Cables may also be routed to one or more other modules that may be mounted within the same chassis or a different chassis. As such, a complex network of cables and modules may be formed. Such cables are typically bundled so that after the cables are connected to the modules, each individual cable can be very difficult to identify and to separate from the other cables. As a result, installation and removal of a cable to a particular module can be time consuming. Furthermore, given that each cable and module is somewhat similar in appearance, erroneous cable installation and removal are unlikely to be detected until electrical malfunctions or signal discontinuities result, after which the single erroneously-connected cable, which is grouped with a multitude of similar cables, must be located and correctly routed and connected. In a complex network of cables and modules such a task may be difficult, inefficient, and generally undesireable.

Electronic components used by communication service providers are typically inserted in standardized racks. These racks have upright supports with spaced openings. The supports are separated by standard distances depending on whether it is a data rack (19 inches) or a telecommunication rack (23 inches). One such standard, specifically the NEBS (Network Equipment Builders System) standard, utilizes a 19 inch spacing and is commonly used by such communication service providers. Brackets and conventional fasteners are used to secure the modules to the upright supports. Various cable routing devices are used to route cables to and along the upright supports of the rack. In general, these devices are attached to the upright supports or module. Cables connected to ports in the front face of the modules may be routed through the cable routing devices, which are typically mounted upon the face or sides of the modules and/or to the upright support frames of the rack. These cable routing devices are designed in varying configurations including hooks, and clasps which receive and route the cables upward or downward along the upright support frame, or horizontally along the face of the module. In general, these devices are fixed in position with a screw or other conventional fastener.

A number of problems exist with current systems for managing cables in communication racks. As a general matter, most communication cables may not perform efficiently if they are crimped or bent tighter than a minimum bend radius. This is particularly true with fiber optic cables because sharp bends affect the optical properties of the cables. As fiber optic cables are displaced, they are subject to bending and other forces. As a fiber bends, the fiber can break resulting in loss of transmission through the fiber. Since fibers carry extremely high signal rates, the breakage of a single fiber can result in a substantial loss of data or voice communications. Telecommunications industry standards generally recognize a minimum bending radius of about one and a half inches for optical fibers.

Furthermore, as the industry demands greater bandwidth and lighter speeds for communication networks, more signal processing equipment is generally required. This increase in signal processing equipment generally requires larger numbers of cables that must be handled.

### SUMMARY OF THE PRESENT INVENTION

The present invention overcomes the deficiencies and shortcomings of the prior art by providing a system and apparatus for supporting and guiding a large number of cables as they are routed to electronics equipment. Such cable management provides for quickly and easily identifying an individual cable or group of cables associated with a particular electronic component especially when handling a large bundle. As a result, a large number of cables entering an electronics enclosure may be organized and handled efficiently.

In one embodiment of the present invention, such advantages are achieved by using a cable guide device for supporting and guiding cables as they are routed to electronic equipment. Preferably, the cable guide device has a cable guide body that has a two-dimensional cable guide surface and a cable guide system along a portion of the cable guide surface. The cable guide system has cable guides spaced along the cable body for guiding cables over the two-dimensional cable guide surface. Further the cable guide body has a common cable support system with at least one cable capture element that extends from the cable guide body in a third dimension with respect to the two-dimensional cable guide surface for supporting cables at multiple levels from the two-dimensional cable guide surface.

Preferably, the cable guide has grooves positioned along an edge of the cable guide surface that define a curved guide path for supporting cables over about a 90° bend. The curved path may be such as is required to maintain a minimum bend radius in fiber optic cables. Further, a cable support tray having cable support grooves is preferably provided to extend from the grooves of the cable guide. The cable guide surface and cable support tray allow cables to be supported and guided individually or in groups while remaining organized. This is especially advantageous for handling fiber optic cables as excessive kinking and bending generally cause serious damage to the cables.

Cable guides are positioned with respect to the cable capture element of the common cable support system so as to support cables along a curved path. Preferably, the cable capture element of the common cable support system is positioned to extend from the cable guide body so as to be able to guide cables from either of the cable guide systems. Again, this is especially advantageous where fiber optic cables are utilized because of the sensitivity of fiber optic cable to excessive kinking and bending. Preferably, guide posts are provided extending from the cable body and may contain capture elements.

An electronic equipment enclosure with a cable management system and apparatus in accordance with the present invention is provided. The enclosure has sidewalls and support structure operatively connecting the sidewalls. The support structure further provides for supporting electronic equipment and components within the enclosure. The enclosure preferably contains a cable guide device operatively supported within the enclosure for supporting cables and guiding the cables as they are routed to the electronic equipment and components.

These and other features and advantages of the present invention will be apparent in the following detailed description of the preferred embodiments when read in conjunction with the accompanying drawings, in which like reference numerals are used to identify the same or similar parts in the several views.

### BRIEF DESCRIPTION OF THE DRAWINGS

The accompanying drawings, which are incorporated in and constitute a part of this specification, illustrate several aspects of the invention and together with the description of the preferred embodiments, serve to explain the principles of the invention. A brief description of the drawings is as follows:

FIG. 1 is a perspective view of a rack-mountable electronics assembly having an enclosure with a cover plate, a door, and a display device mounted within the door, and in particular showing the electronics assembly mounted on a set of rails and containing a cable management system in accordance with the present invention;

FIG. 2 is a perspective view of the rack-mountable electronics assembly of FIG. 1 showing the door in an opened position and pulled away from the electronics assembly on a pivotable arm, and further illustrating the cable management system mounted within the enclosure of the rack-mountable electronics assembly;

FIG. 3 is a perspective view of the rack-mountable electronics assembly of FIGS. 1 and 2 showing the door in an opened position and pulled away from the electronics assembly but rotated toward the electronics assembly so as to be able to view the display device and components within the electronics assembly simultaneously, and further showing the cover plate of the electronics assembly removed to show the cable management system;

FIG. 4 is a rear perspective view of the rack-mountable electronics assembly of FIG. 1 showing rear mounted electronics components a cooling fan, and in particular showing a side opening and rear opening for introducing cabling into the electronics enclosure;

FIG. 5 is a perspective view of the cable management system illustrated in FIG. 2 showing a cable support tray and a cable guide plate having cable capture trees, cable support pins, and cable guide pins;

FIG. 6 is a perspective view of the cable support tray of FIG. 5 showing in particular cable guiding grooves;

FIG. 7 is a perspective view of the cable guide plate of FIG. 5 showing in particular cable saddles;

FIG. 8 is a front view of the cable guide plate of FIG. 5 showing in particular minimum bend radius guidelines for fiber optic cables;

FIG. 9 is a rear view of the cable guide plate of FIG. 5;

FIG. 10 is side view of the cable guide plate of FIG. 5;

FIG. 11 is a top view of the cable guide plate of FIG. 5;

FIG. 12 is a partial cross-section view taken along line 12-12 in FIG. 8 showing in particular a recess for mounting the cable capture trees illustrated in FIG. 5;

FIG. 13 is a perspective view of the cable capture tree illustrated in FIG. 5 showing in particular a base with mounting holes for securing the cable capture tree to the cable guide plate illustrated in FIG. 5 and also illustrating openings for inserting cables into capturing regions;

FIG. 14 is a top view of the cable capture tree of FIG. 5 showing in particular the capturing regions;

FIG. 15 is a side view of the cable capture tree of FIG. 5 showing in particular the mounting holes;

FIG. 16 is a top view of an alternate embodiment of a cable capture tree of the present invention showing in particular a different alternate number of capturing regions on each side of the cable capture tree; and,

FIG. 17 is a top view of an alternate embodiment of a cable capture tree of the present invention showing in particular capturing regions having various sizes.

### DETAILED DESCRIPTION OF THE PREFERRED EMBODIMENTS

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

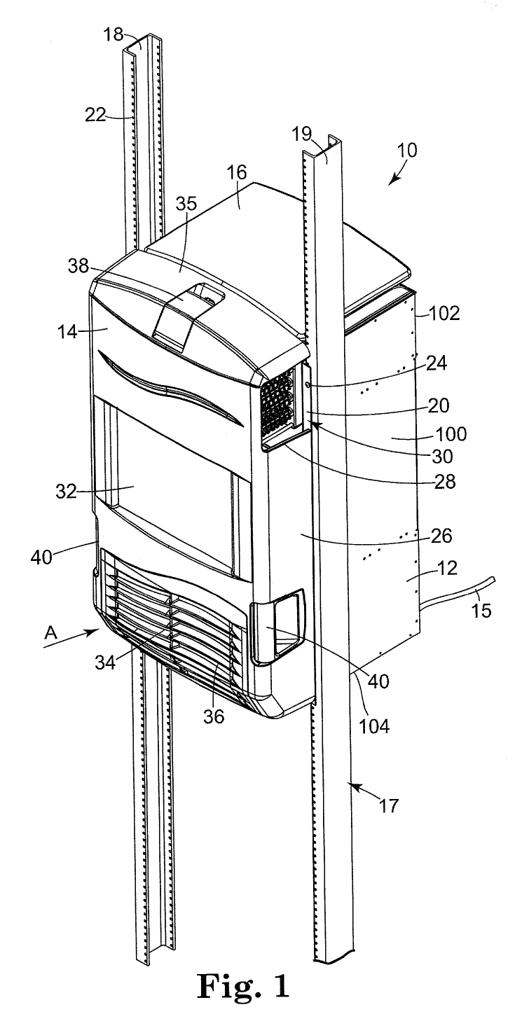

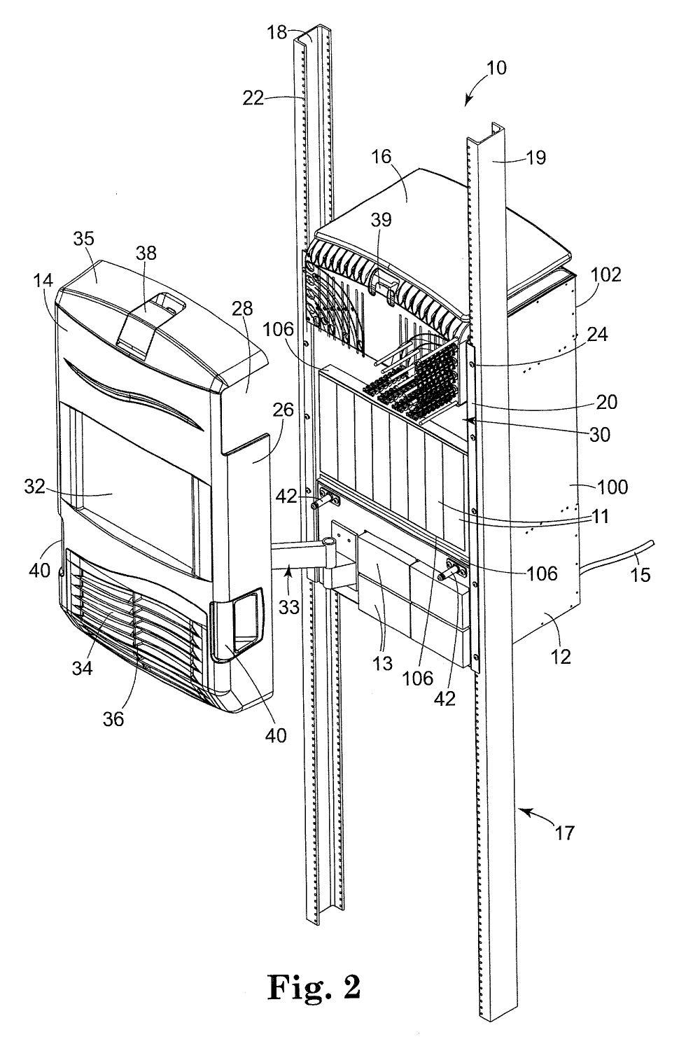

Illustrated in FIGS. 1 and 2 is a rack-mountable electronics assembly 10 in accordance with an embodiment of the present invention. The electronics assembly 10 may, for example, be a signal processing unit for use in the telecommunications industry. The electronics assembly 10 may include signal-processing equipment 11 for example, line cards, routers, switches, and the like as well as other modules 13, such as may be one or more power supplies, cooling modules, and the like. The electronics assembly 10 may further include a main power cable 15 for delivering outside power to the electronics assembly 10. The main power cable 15 is preferably introduced through a back wall 102 of the electronics assembly 10 however; the main power cable 15 may be introduced through any wall of the electronics assembly 10 such that the functional aspects of the present invention are realized. As will be discussed below, the electronics assembly 10 preferably includes a cable management device or system 30 for handling cables associated with the signal processing equipment 11 and for handling any other cabling within the electronics assembly 10.

As illustrated in FIGS. 1 and 2, the electronics assembly 10 generally includes an enclosure 12, a door 14, a cover plate 16, and the cable management system 30. Specific details of the enclosure 12, door 14, cover plate 16, and cable management system 30 are set out below. Preferably, the electronics assembly 10 is mounted to and supported by a support structure 17 having a first vertically mounted rail 18. As illustrated in FIGS. 1 and 2, the rail 18 may be generally U-shaped in cross-section and preferably has fastener holes 22 spaced evenly apart along the rail 18 at a predetermined distance. Preferably the support structure 17 is provided having a second rail 19 spaced at an industry standard distance from the first rail 18.

Preferably the first rail 18 and the second rail 19 are substantially parallel. In a preferred embodiment, the first rail 18 and the second rail 19 are spaced at an industry standard distance of 19 inches such as the NEBS (Network Equipment Builders System) standard. Preferably, such support structures 17 are mounted to additional supporting frame structures (not shown) and extend from floor to ceiling within buildings. Likewise, other indoor applications may include mounting the electronics assembly 10 to walls, poles, or other structures. It is contemplated that the support structure 17 may be utilized such that access to all sides of the electronics assembly 10 is available.

Preferably, a plurality of support structures 17 may be provided such that electronics assemblies 10 are arranged in a side by side configuration thereby efficiently utilizing space. Further, it is contemplated that, multiple electronics assemblies 10 may be mounted on the same support structure 17 thus creating a stacked arrangement of electronics assemblies 10. As such, a side by side and/or stacked arrangement of electronics assemblies 10 may be accomplished thereby satisfying any applicable space utilization requirements.

It is noted that similar electronics assemblies may be utilized in outdoor applications, such as electronics assemblies mounted onto exterior walls of buildings and utility poles and other such structures. As such, the functional aspects of the cable management system of the present invention would not be precluded for such outdoor applications.

In a preferred embodiment, the enclosure 12 has sidewalls 100, the back wall 102, and a bottom wall 104. The enclosure 12 may be formed by any known or developed technique. For example, sidewalls 100, back wall 102, and bottom wall 104 may be formed from sheet material and as individual components and joined together by welding. Alternatively, sidewalls 100, back wall 102, and bottom wall 104, maybe formed from sheet material and as individual components and having flanges allowing for fastening together with rivets, screws, or the like, as is conventionally known. As another alternative, the enclosure 12 may be formed by bending a single sheet of material or multiple sheets of material thereby forming the sidewalls 100, back wall 102, and bottom wall 104 and joined together using a technique described above.

The enclosure 12 may include frame structures 106, as illustrated in FIG. 2, for providing structural strength, dividing the enclosure 12 into multiple zones, or for providing mounting points for internal components of the enclosure 12. In FIG. 2, exemplary horizontal frame structures 106 are illustrated. The frame structures 106 may be mounted within the enclosure 12 to extend between sidewalls 100 (as illustrated in FIG. 2) or may be mounted to be substantially horizontal (not shown) to extend from the bottom wall 104 or in any combination of horizontal and vertical structure such that the functional aspects of the present invention are realized. For example, the frame structures 106 may be formed as a single frame unit having the sidewalls 100, back wall 102, and bottom wall 104 attached thereto by any conventional means. As illustrated in FIG. 2, frame structures 106 divide enclosure 12 into three zones. That is, a zone for the cable management system 30, the signal processing equipment 11, and the other modules 13 is provided. It is noted that the enclosure 12 may be divided by any number of frame structures 106 to create any number of zones desired.

Preferably, the enclosure 12 has a flange 20 extending outward from each sidewall 21 of the enclosure 12 for mounting the electronics assembly 10 to the support structure 17. That is, the flange 20 of the electronics assembly 10 is attached to rail 18 on one side and to rail 19 on the opposite side. As illustrated in FIG. 2 the flange 20 is preferably L-shaped in cross-section and includes mounting holes (not shown) for attaching the flange 20 to rail 18 and rail 19 via tapped holes 22 thereby supporting the electronics assembly 10 on the rail 18 and rail 19. It is known that the flange 20 may be any known or developed structure capable of attaching the electronics assembly 10 to the rail 18 and rail 19. That is, the flange 20 is not required to be an integral part of the enclosure 12. The flange 20 may be a separate structure for example, a bracket. It is noted that any suitable fasteners 24 may be used to secure the electronics assembly 10 to the rail 18 and rail 19. In an alternate embodiment, the electronics assembly 10 may be implemented as a tabletop electronics assembly. That is, any such supporting rail, such as rail 18 and rail 19, may be omitted. It is noted that the manner of supporting the electronics assembly 10 does not form a specific part of the present invention and may comprise any conventional or developed structure.

As mentioned above, the electronics assembly 10 preferably include the door 14. Preferably, the door 14 has opposing sidewalls 26 and at least one opening 28 in each sidewall 26 for passing cables from outside the electronics assembly 10 to inside the electronics assembly 10. As described below, cables pass through the opening 28 and are arranged by the cable management system 30 within the enclosure 12. As illustrated in FIGS. 1 and 2, the opening 28 may be generally square. Further, the opening 28 may be in one sidewall 26 of the door 14 or may be in both opposing sidewalls 26 of the door 14. As described below, the opening 28 is preferably positioned in the sidewall 26 of the door 14 such that is aligned with the cable management system 30. Preferably, the opening 28 is open at an end such that the door 14 can be opened without disturbing cables passing through the opening 28 and secured by the cable management system 30. The opening 28 may be of any shape as long as the functional aspects of the present invention are realized. That is, the shape of the opening 28 is not critical as long as a predetermined number of cables can pass through it and remain sufficiently undisturbed when the door 14 is opened or removed. It is preferable that cables can pass through the opening 28 and be supported by the cable management system 30 such that they remain untangle and organized. Preferably the opening 28 has a rectangular shape however, the opening 28 may have a circular shape or any other shape that allows cables to pass through the door 14. It is contemplated that the opening 28 may additionally have a structure or mechanism utilized for strain relief of the cables passing through the opening 28. For example, the opening 28 may have a clamp type structure (not shown) for strain relief of the cables such that a portion of clamp could be removed in order to open the door 14 without disturbing the cables.

As shown in FIGS. 1 and 2, the door 14 preferably includes a latch 38 positioned centrally at the top of the door 14 for securing to latch tab 39 and thereby securing the door 14 to the enclosure 12. Preferably the latch tab 39 is independent of the cover plate 16 so that the cover plate 16 may be removed while the door 14 is secured to the enclosure 12. As described below, the cover plate 16 may be omitted entirely. Preferably the latch tab 39 is a feature of the cable management system 30 however, the latch tab 39 may be a feature of the cover plate 16 or may be a feature of the enclosure 12 such that the functional aspects of the present invention are accomplished. Also shown in FIGS. 1 and 2, the door 14 preferably includes a releasable handle 40 as part of each sidewall 26. Each releasable handle 40 engages a pin 42 and secures the door 14 to the enclosure 12. Typically the pin 42 and releasable handle 40 combination includes a spring and detent (not shown) to make the closure. The latch 38 and each releasable handle 40 secure the door 14 to the enclosure 12. In demounting the door 14 from the enclosure 12, first, the latch 38 is opened and thereby releasing the latch 38 from the latch tab 39. Next, using both hands, each releasable handle 40 is disengaged simultaneously thereby filly releasing the door 14 from the enclosure 12. It is known that any conventional or future developed latching arrangement may be used to secure the door 14 to the enclosure 12. That is, the latch 38 and latch tab 39 as well as the releasable handle 40 and pin 42 may be replaced by any conventional or future developed mechanism or means such that the functional aspects of the present invention are realized.

Preferably, as illustrated in FIG. 1, the door 14 also includes a ventilation grill 34. The ventilation grill 34 includes air intake apertures 36 for permitting air to flow into the electronics assembly 10 in order to cool the internal electronic components of the electronics assembly 10. The air intake apertures 36 may be any such openings that permit air to enter the enclosure 12 in accordance with the functional aspects of the present invention. As illustrated in FIG. 1 air may generally flow in the direction of arrow A, pass through the air intake apertures 36 and through the an opening provided in the door 14 (not shown) to enter the enclosure 12. As illustrated FIG. 1, the ventilation grill 34 is preferably formed as a single structure. It is contemplated that the ventilation grill 34 may be formed as an integral part of the door 14. That is, the door 14 and ventilation grill 34 may be formed as a single structure. It is further contemplated that the ventilation grill 34 may be formed as a plurality of structures that are either attached to the door 14 or formed as part of a single structure door 14. The ventilation grill 34 is the subject of commonly owned co-pending U.S. design patent application Ser. No. ______ ,” entitled Ventilation Grill, filed on even date herewith, and the entire disclosure of which is fully incorporated herein by reference.

The ventilation grill 34 may include an air filter (not shown). Such an air filter may be used to prevent dust and other harmful contaminants from entering the electronics assembly 10. Preferably the air filter is sandwiched between the ventilation grill 34 and the door 14. The door 14 may include an opening as described above and a flange or other such structure (not shown) for retaining the air filter. The air filter may be captured between the ventilation grill 34 and the flange. It is contemplated that the air filter 35 may be any known or developed filtration media, multiple layers, or formed media with or without additional filter frames.

As shown in FIG. 4, the enclosure 12 may include at least one fan 37 for drawing air into the electronics assembly 10 for providing cooling to the components within the electronics assembly 10. Preferably, air flows in the direction of arrow A (see FIG. 1) into the air intake apertures 36 and through the electronics assembly 10 under the drawing force of the fan 37. Preferably, the fan 37 is mounted to the inside of the rear panel 102 of the enclosure 12 by using mounting holes 108 and any conventional fasteners (not shown). In a preferred embodiment the rear panel 102 of the enclosure 12 includes at least one air passage 110 for permitting air to exit the enclosure 12 under the drawing force of the fan 37. Preferably, the fan 37 is positioned over the air passage 110. The number and type of fans 37 utilized is dependent upon the particular components within the electronics assembly 10. That is, certain components require a greater degree of cooling and as such would require greater airflow through the electronics assembly 10.

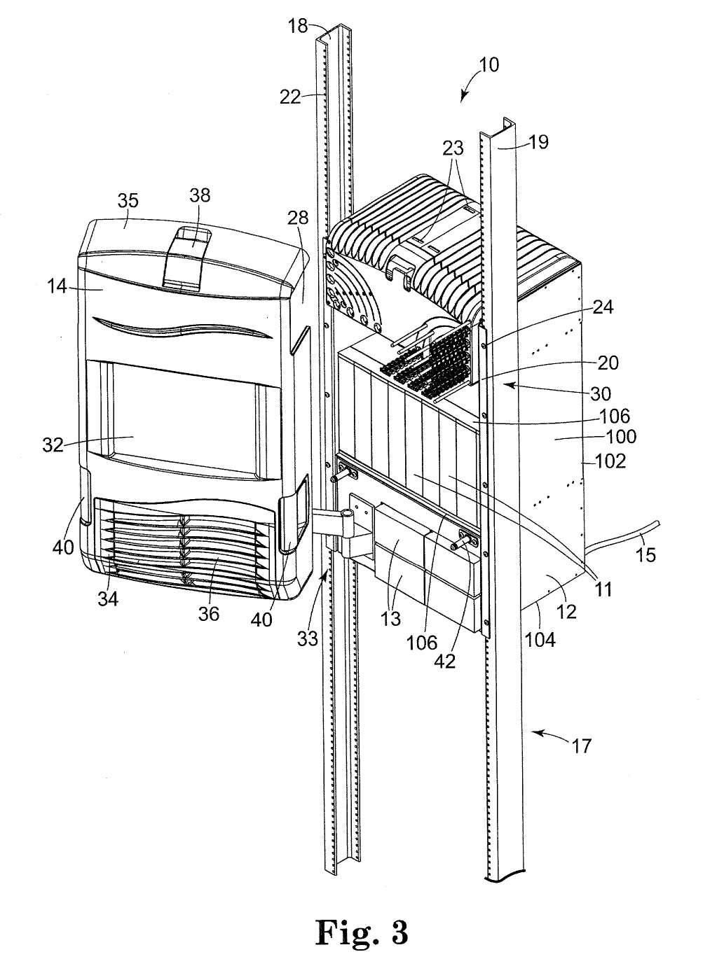

In a preferred embodiment, the door 14 is connected to the enclosure 12 using a pivotable arm assembly 33 as illustrated in FIGS. 2 and 3. Further referring to FIGS. 1 and 2, the door 14 preferably includes at least one display device 32 as described below and mounted operatively as an integral part of the door 14. In FIG. 2 the door 14 is illustrated in an open position and pulled away from the closed position illustrated in FIG. 1. In FIG. 3 the door 14 is illustrated in an open position pulled away from the enclosure 12 but rotated towards the enclosure 12. In the rotated position of FIG. 3 the display device 32 of the door 14 and the equipment within the enclosure are simultaneously viewable. That is, the signal processing equipment 11 and the other modules 13 may be easily seen at the same time as the display device 32. Further, the door 14 may be positioned in a wide range of locations for viewing the display device 32. A technician working behind or to the side of the electronics assembly 10 could easily place the door 14 in a position to readily view the display device 32.

By a display device, it is meant any electronic device known or developed that can provide visual communication based upon one or more of the electronic components to which is attached. Preferably, the display device 32 is an input capable display device. That is, it is preferably an interface to permit two-way communication with electronic components to which it is attached. For example, the input capable display device may be connected to the signal processing equipment 11 to accomplish setup or diagnostics etc., or may be merely a warning device, preferably both.

Preferably, the display device 32 is a touch screen display capable of providing two-way communication with components to which it is connected. The display device functions as both a display device and input device such that a technician may input commands and the like to communicate with attached equipment. It is contemplated that any input capable display device may be used. That is, commands are entered through the display device by touching the screen with a finger or stylus or through the use of a keyboard or other remote means for communicating therewith, which keyboard can be also directly mounted to the door 14 or plugged into the display and may further utilize wireless communication technology either known or developed.

The display device 32 is preferably a flat panel input capable display device having a low profile for efficient space utilization such as a liquid crystal display, light emitting diode display, field emission display, plasma display, or the like. The display device 32 may be any such size and shape facilitating such use such that the functional aspects of the present invention are realized. The display device 32 may be a black and white display or may be a color display. Preferably the display device 32 is a commercially available touch screen display model NIS-TNC-1503-215 as commercially available from ELO TouchSystems of Fremont, Calif. The door 14 including the arm 33 and display device 32 illustrated in FIGS. 1-3 is the subject of commonly owned co-pending U.S. patent application Ser. No. ______,” entitled “Closure for Equipment Case Having an Integrated Display” , filed on even date herewith, and the entire disclosure of which is fully incorporated herein by reference.

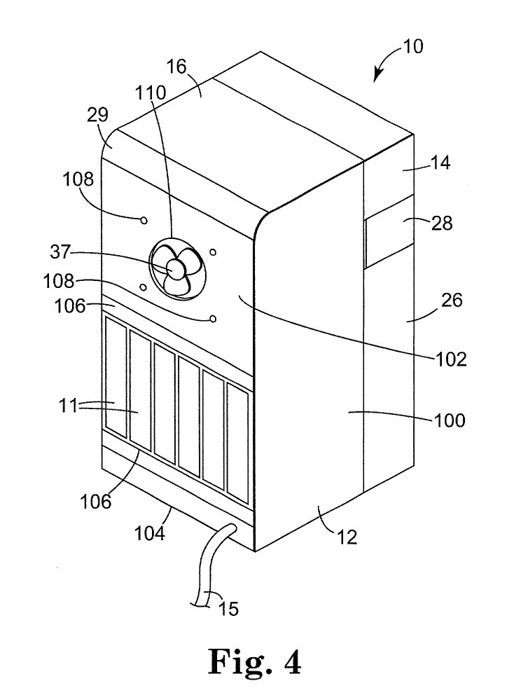

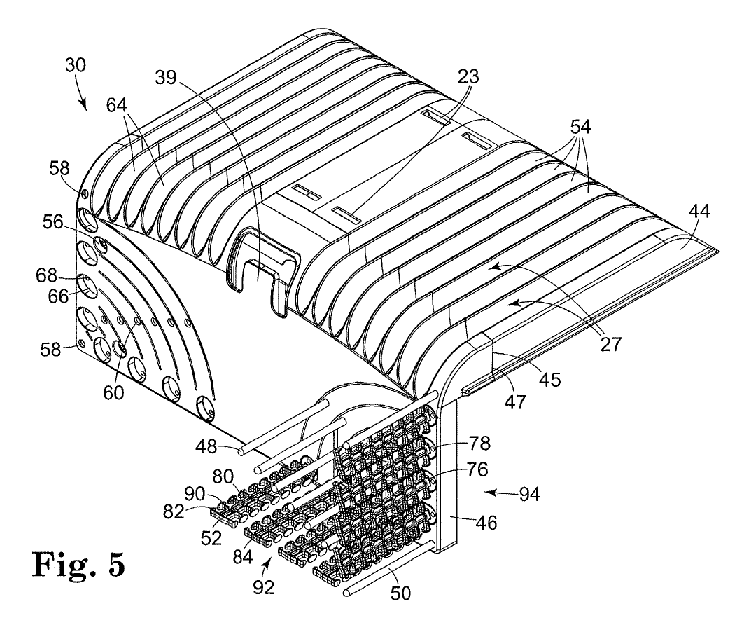

The cable management device system 30 is illustrated in FIG. 5. Preferably, the cable management system 30 includes a cable support tray 44, a cable guide body or plate 46, a plurality of cable support posts or pins 48, a plurality of cable guide posts pins 50, and a plurality of cable capture elements or trees 52. A detailed description of each of these components is provided below. For clarity, only a portion of the cable guide plate is illustrated in FIG. 5 being populated with cable support pins 48, cable guide pins 50, and cable capture trees 52. The cable management system 30 is preferably supported within the enclosure 12 using frame structure 106. That is, the cable guide plate may be mounted to frame structure 106 or any other frame structure within the enclosure 12 to extend between sidewalls 100 at the top of the enclosure 12. Specific details of the mounting of the cable management system 30 are described below.

Preferably the cable support tray 44 is positioned so as to be generally horizontal and mounts to the cable guide plate 46 as described below. Preferably in the cable guide plate 46 is positioned to be generally vertical with respect to the cable support tray 44. It is contemplated that the cable support tray 44 may be positioned at an angle away from the horizontal position described above. That is, the cable support tray 44 may be tilted at any angle away from horizontal such that the functional aspects of the present invention are accomplished. It is further contemplated that the cable guide plate 46 may be positioned at an angle away from the vertical position described above. That is, the cable guide plate 46 may be tilted at any angle away from vertical such that the functional aspects of the present invention are accomplished. Preferably, as described below, the cover plate 16 mounts to the cable support tray 44 by using mounting features 23 illustrated in FIG. 3.

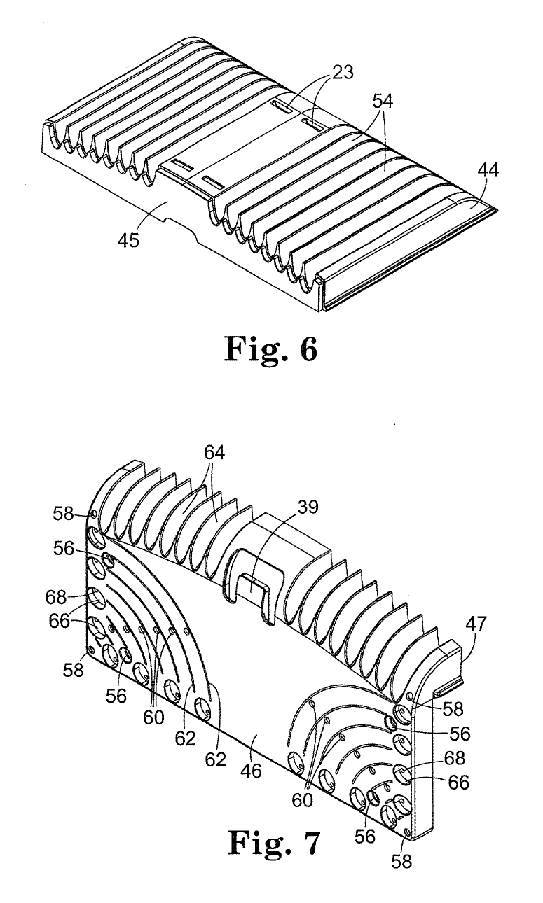

Referring to FIG. 6, the cable support tray 44 of the cable management system 30 is illustrated. In the preferred embodiment, the cable support tray 44 is positioned generally horizontally and is preferably perpendicular to the cable guide plate 46 which is positioned generally vertically. As described below, the cable support tray 44 and the cable guide plate 46 function together to guide cables that enter the electronics assembly 10 from one direction (i.e. the back of the enclosure 12) to a particular electronic component within the electronics assembly 10 such that cables remain organized, untangled, and easily accessible. That is, the cable support tray 44 and the cable guide plate 46 form continuous individual guide grooves 27 for guiding the cables.

Preferably, the cable support tray 44 includes a plurality of cable support grooves 54 for guiding and supporting cables. The cable support grooves 54 may have indicia related to electronic components, such as signal processing equipment 11 and other components 13, for associating cables with specific locations. Typically, the cable support grooves 54 are spaced at a distance apart such that a predetermined number of cables may be handled. Further, the cable support grooves 54 have a depth facilitating such use. That is, the cable support grooves 54 have a depth and width so as to be able to support and guide at least one cable of predetermined size and preferably a plurality of cables thereby forming a bundle of cables. Cables handled by the cable support tray 44 remain organized and untangled because specific cables associated with specific equipment within the electronics assembly 10 may be assigned to designated support grooves 54. For example, each groove 54 can be associated with those cables directed to one identifiable electronic component (or portion thereof) provided within the enclosure 12. Moreover, the support grooves 54 prevent cables from sagging and also from becoming entangled with each other. This is especially important when fiber-optic cables are used because fiber-optic cables are highly sensitive to bending and kinking such as that caused by entangling of cables. The cable support tray 44 allows for cables to remain separated and untangled such that when an individual cable or group of cables needs to be replaced or troubleshooted it may easily be identified and thereby handled without the risk of damage. Preferably, the cable support tray 44 is fabricated as a thin-walled type structure. For example, the cable support tray 44 may be made of a molded plastic or light metal facilitating such use.

As illustrated in FIG. 6, the cable support tray 44 includes a mating feature 45 for attaching the cable guide plate. Preferably, as described below, the mating feature 45 allows for positive alignment with the cable guide plate 46. Further, the cable support tray 44 includes openings 23 for attaching cover plate 16. Preferably, the openings 23 allow for the cover plate 16, as shown in FIG. 2, to be quickly and easily installed or removed. The cover plate 16 may be provided to confine wires or cables within the grooves 54. That is, in a preferred embodiment, the cover plate 16 includes tabs (not shown) that fit into the openings 23 thereby engaging the cover plate 16. Such tabs may by a friction fit type or any other releasable fastener such as latches, clamps, screws, and the like. It is noted that, any known or developed means for attaching cover plate 16 to the cable support tray 44 may be used as long as the function goals of the present mentioned are realized.

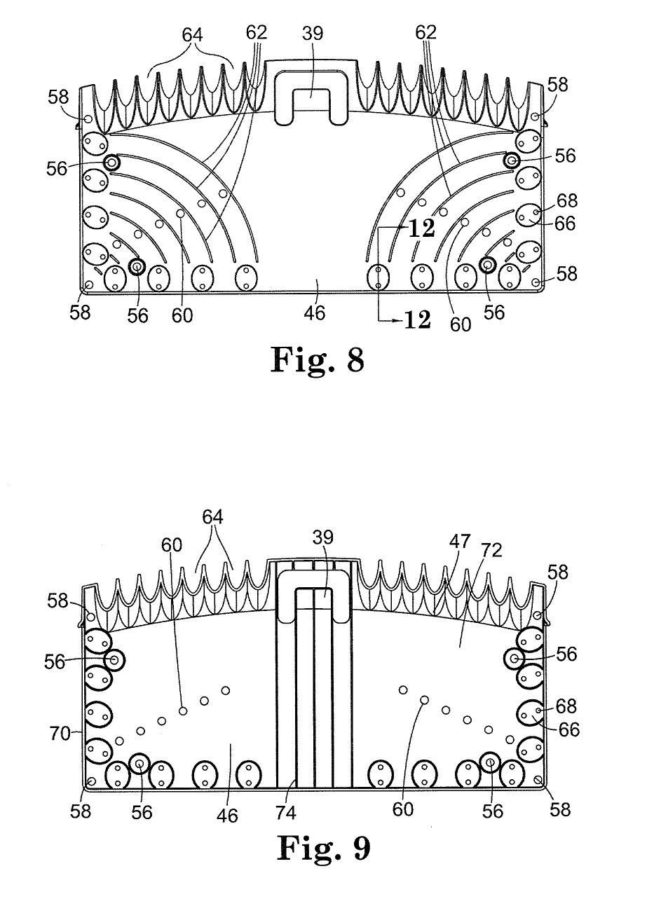

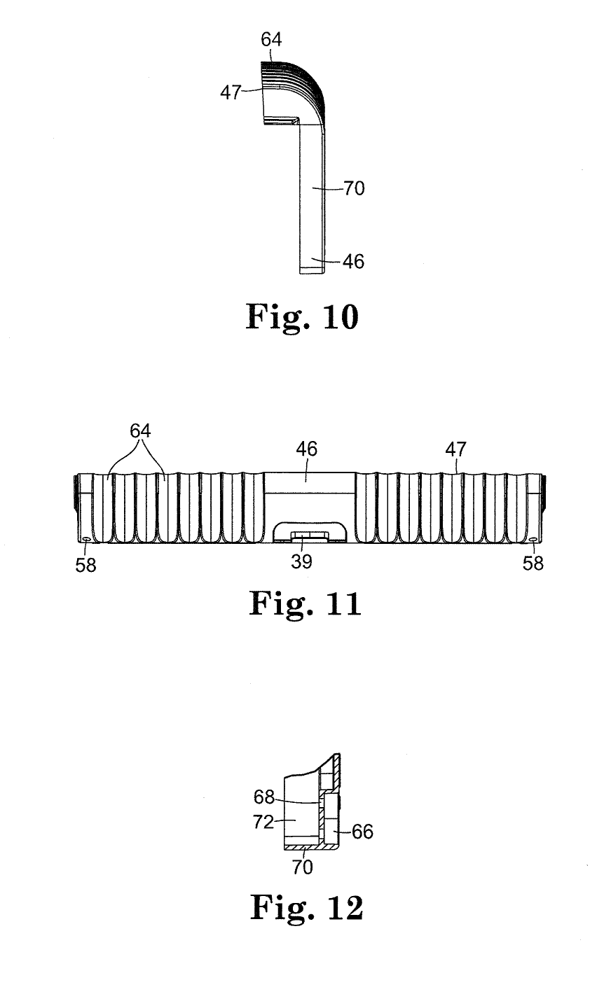

Referring to FIGS. 7-11, the cable guide plate 46 will be described. In FIG. 7, a perspective view of the cable guide plate 46 is shown. In FIGS. 8 and 9, a front view and a rear view of the cable guide plate 46 are shown respectively. The rear view of FIG. 9 particularly illustrates features not illustrated in the perspective view of FIG. 7. In FIG. 10, a side view of the cable guide plate 46 is shown. In FIG. 11, a top view of the cable guide plate 46 is shown. Preferably, the cable guide plate 46 is of a thin-walled type structure as is illustrated in FIG. 9. As is described below the cable guide plate 46 preferably has a wall 70 and a cavity 72. For example, the cable guide plate 46 may be made of a molded plastic or light metal facilitating such use. Preferably, as described above, the cable guide plate includes a latch tab 39 for engaging the latch 38 of the door 14.

As can be seen in FIGS. 7-9, the cable guide plate 46 preferably includes mounting holes 56. The mounting holes 56 are used to attach the cable guide plate 46 to supporting structures (not shown) within the enclosure 12. Preferably, supporting structures are provide so that the cable guide plate may be attached and position at or near the top of the electronics enclosure 10 and extending between the sidewalls 100. It is contemplated that the cable guide plate 46 may be mounted at any location within the electronics assembly 10. That is, the cable management system 30 may be positioned near the bottom or near the center of the electronics assembly 10. It is noted that any support structure within the enclosure 12 may be used to mount the cable guide plate 46. It is further noted that any suitable fasteners (not shown) may be used to secure the cable guide plate 46 to the supporting structures.

The cable guide plate 46 preferably also includes a mating feature 47 for positively aligning the cable guide plate 46 to the cable support tray 44. The mating feature 47 of the cable guide plate 46 is illustrated in FIG. 9. Preferably, the mating feature 47 forms a cavity for receiving the mating feature 45 of the cable support tray. Referring to FIG. 6 the mating feature 45 of the cable support tray 44 is illustrated. As illustrated, mating feature 45 of the cable support tray 44 extends from the cable support tray 44 and forms a raised section thereof. Preferably, the mating feature 47 of the cable guide plate 46 and the mating feature 45 of the cable support tray 44 fit together such that the cable support grooves 54 of the cable support tray 44 and cable saddles 64 of the cable guide plate 46 form continuous channels 27. Preferably, the cable guide plate 46 and the cable support tray 44 are held together by a frictional fit or the like. It is known that any method of securing the cable guide plate 46 and the cable support tray 44 may be used. For example, fasteners such as screws and latches and the like may be used. Also, fastening by welding or gluing may be used. It is known that any combination of mating features for the cable support tray 44 and the cable guide plate 46 may be used such that the continuous channels 27 are formed and such that the functional aspects of the present invention are accomplished. It is further contemplated that the cable support tray 44 and the cable guide plate 46 may be fabricated as a single part.

As illustrated in FIGS. 7-11 the cable guide plate 46 includes a plurality of cable saddles 64. Preferably, the cable saddles 64 of the cable guide plate 46 are positioned at the top of the cable guide plate 46 as is illustrated in FIG. 7. As can be seen in the perspective view of FIG. 7 and more particularly, in the side view of FIG. 10 the cable saddles 64 have a predetermined radius for guiding cables in a downward direction. Preferably, the radius is equal to or greater than the radius that is required as a minimum bend radius for fiber optic cables. As illustrated in FIG. 5 the cable saddles 64 preferably interface with the cable support grooves 54 of the cable support tray 44 thereby creating a plurality of continuous channels 27 for guiding and supporting cables. In the preferred embodiment, cables entering through the rear of the electronics assembly 10 are guided and supported by the continuous channels 27 of the cable management system 30. That is, referring to FIG. 4, cables enter the electronics assembly 10 through rear opening 29 that is formed by the rear wall of the enclosure 31 and the cover plate 16. Cables are supported and guided by the continuous channels 27 from the rear of the electronics assembly 10 to the front of the electronics assembly 10 and are further guided in a downward direction by the cable saddles 64 of the cable guide plate 46. As such, individual cables or groups of cables may be neatly transferred from the outside of the electronics assembly to the components within the electronics assembly. This prevents cables from becoming entangled with each other and allows for rapid and efficient service when troubleshooting and/or replacement is necessary.

Further referring to FIGS. 7-9, the cable guide plate 46 preferably includes a plurality of mounting holes 58 for cable guide pins 50. As described below, the cable guide pins 50 guide the cables that enter the electronics assembly 10 through the opening 28 in the sidewall 26 of the door 14 and prevent cables from being pinched by the door 14. The cable guide plate 46 also preferably includes a plurality of mounting holes 60 for cable support pins 48. As described below the cable support pins 48 act to help maintain a minimum bend radius for fiber optic cables. As illustrated in FIG. 8 the cable guide plate 46 also preferably includes minimum bend radius guidelines 62 for visually establishing the minimum bend radius of a fiber optic cable mounted within the cable management system 30. This allows a technician to easily position and guide cables that are supported within the cable management system 30.

Referring to FIGS. 7 and 8, the cable guide plate 46 preferably includes a plurality of recesses 66 for mounting the cable capture trees 52 to the cable guide plate 46. The recesses 66 include mounting holes 68 for attaching the cable capture trees 52 to the cable guide plate 46. In FIG. 12 a partial cross-section of the cable guide plate 46 taken along line 12-12 of FIG. 8 is shown and illustrates the recess 66 and the mounting holes 68.

Referring to FIG. 9 the cable guide plate 46 is illustrated from the back side opposite of that illustrated in FIG. 8. As described above, the cable guide plate 46 is preferably a thin-walled 3-dimensional structure. It is contemplated that the cable guide plate 46 may be a solid structure such that the functional aspects of the present mentioned are realized. Referring to the rear view of FIG. 9 the cable guide plate 46 preferably includes the wall 70 that continues around the perimeter of the cable guide plate 46 thereby creating a thin-walled structure having the cavity 72. The cable guide plate 46 also preferably includes a plurality of support ribs 74 that extend vertically between opposite vertical sides of the wall 70. Such support ribs 74 provide structural reinforcement to the thin walled structure of the cable guide plate 46. It is contemplated that the ribs 74 may be provided either horizontally or vertically or may be provided as a perpendicular arrangement of ribs or a honeycomb arrangement of ribs such that the functional aspects of the present mentioned are realized. That is, the cable guide plate 46 is more rigid by using support ribs 74.

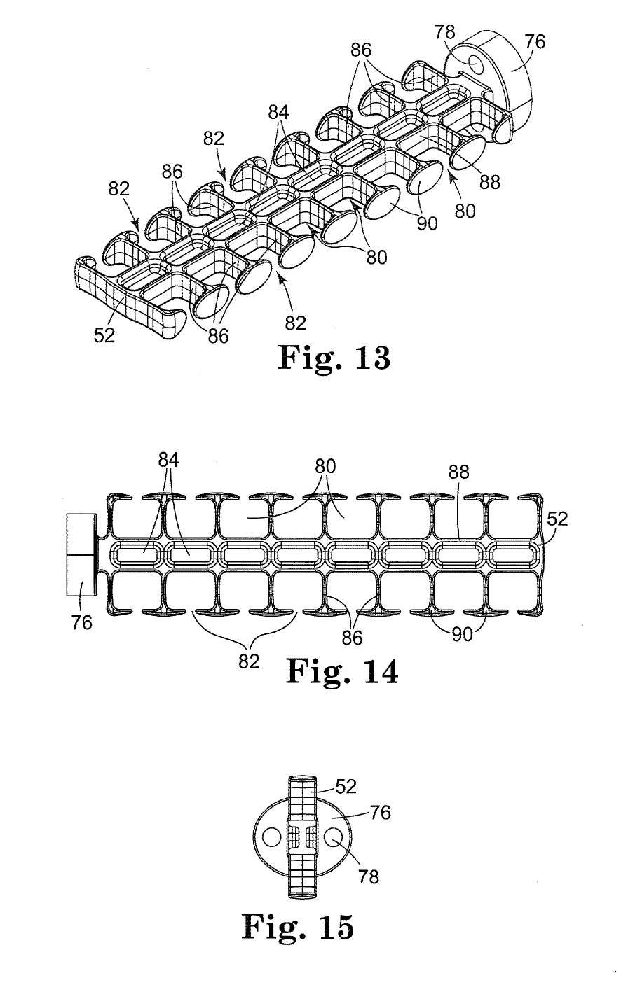

In FIG. 13 a cable capture tree 52 is illustrated in perspective view. In FIG. 14 a top view of the cable capture tree 52 is illustrated. In FIG. 15 a side view of the cable capture tree 52 is illustrated. Referring to FIGS. 13-15 the cable capture tree 52 preferably includes a base 76 having mounting holes 78. The base 76 of the cable capture tree 52 preferably has a generally round shape and a thickness facilitating such use. The base 76 of the cable capture tree 52 preferably fits into the recess 66 of the cable guide plate 46 for mounting to the cable guide plate 46. The mounting holes 68 on the cable guide plate 46 and the mounting holes 78 on the base 76 of the cable capture tree 52 are used for securing the cable capture tree 52 to the cable guide plate 46. It is known that any means of attaching the cable capture tree 52 to the cable guide plate may be used. That is, the cable capture tree 52 may be attached to the cable guide plate by any means such that the functional aspects of the present invention are realized. It is noted that any suitable fastener may be used for securing the cable capture tree 52 to the cable guide plate 46. Preferably the fastener is a type that is easily demountable so as to facilitate the quick and easy removal of the cable capture tree 52 from the cable guide plate 46. Removal of the cable capture trees 52 from the cable guide plate 46 may allows for easy reconfiguration or modification of the cable management system 30.

Preferably, a plurality of cable capture trees 52 are arranged and attached to the cable guide plate 46 forming at least one horizontal group of cable capture trees 92. That is, a linear arrangement of cable capture trees 52 is provided along a lower horizontal edge of the cable guide plate 46 as is shown in FIG. 5. Preferably, a second horizontal group of cable capture trees (not shown) is provided. It is noted that FIG. 5 only illustrates one horizontal group of cable capture trees 92. It is noted that, any number of cable capture trees 52 may be used to form the horizontal group 92. The second horizontal group of cable capture trees 92 is omitted to illustrate the mounting recesses 66. The preferred orientation of the individual cable capture trees 52 of the horizontal group of cable capture trees 92 is described below.

Also preferably, a plurality of cable capture trees 52 are arranged and attached to the cable guide plate 46 forming at least one vertical group of cable capture trees 94. That is, a linear arrangement of cable capture trees 52 is provided along at least one vertical side edge of the cable guide plate 46 as in shown in FIG. 5. Preferably, a second vertical group of cable capture trees (not shown) is provided. It is noted that FIG. 5 only illustrates one group of vertical cable capture trees 94. It is noted that, any number of cable capture trees 52 may be used to form the vertical group 94. The second vertical group of cable capture trees 94 is omitted to illustrate the mounting recesses 66. The preferred orientation of the individual cable capture trees 52 of the vertical group of cable capture trees 92 is described below.

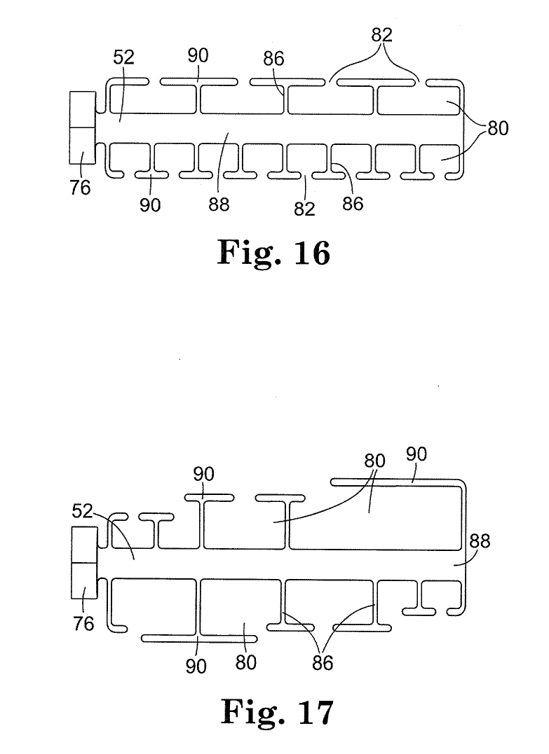

Further referring to FIGS. 13-15 the cable capture tree 52 preferably includes a plurality of ribs 86 that extend outward from a main body section 88 of the cable capture tree 52. The main body section 88 is attached to the base 76 of the cable capture tree 52 and extends outward therefrom. In the preferred embodiment the ribs 86 extend outward from both sides of the main body section 88 as is illustrated in FIG. 14 thereby forming a symmetrical structure. It is noted that a different number of ribs 86 may extend from opposite sides of the main body section 88 or from a single side of the main body section 88 as is illustrated in FIG. 16.

The ribs 86 are spaced apart at a predetermined distance and extend outward from the main body section 88 at a predetermined distance and have end elements or sections 90 having a predetermined width thereby forming capturing regions 80 and passages 82. The spacing of the ribs 86, the distance in which the ribs 86 extend outward from the main body section 88, and the width of the end sections 90 are chosen such that the capturing regions 80 and the passages 82 are appropriately sized for the particular cables to be used. In the preferred embodiment, an equal number of capturing regions are formed on each side of the main body section 88. The total number of capturing regions 80 may be correlated to the number of cables utilized with a particular component within the electronics assembly. For example, individual signal processing modules 11 or electronic components within the electronics assembly 10 may contain a predetermined number of cables and individual cable capture trees 52 having the same number of capturing regions 80 may be assigned to each signal processing modules 11. Also, an individual signal processing module 11 or electronic component within the electronics assembly 10 may be assigned to one side of a cable capture tree 52 or to one capturing region 80. Further, individual capturing regions 80 and/or cable capture trees 52 may be provided with indicia designating regions 80 for a particular signal processing module 11 or electronic component within the electronics assembly 10.

As shown in FIG. 14 a plurality of capturing regions 80 are formed having passages 82 for receiving cables. The passages 82 are defined by the width of the end sections 90. The passages 82 allow for a cable of a predetermined size to enter the capturing regions 80. That is, the size of passages 82 is related to cable size to permit entry of cables into regions 80. Preferably capturing regions 80 are larger than passages 82 thereby facilitating the introduction of many cables. As such, a single cable or a plurality of cables may be introduced to the capturing regions 80 and thereby retained. As illustrated in FIG. 17 capturing regions 80 of varying sizes may be formed for retaining either a single cable or a group of cables or cables having different sizes. That is, the spacing and length of the ribs 86 may vary so as to define a plurality of capturing regions 80 having varying size.

The cable capture tree 52, as illustrated in FIG. 13, also includes openings 84 within the main body section 88. The openings 84 are preferably provided to facilitate a lightweight structure and to provide for ease of manufacturing. It is contemplated that the main body section 88 may be provided as a solid structure.

Referring to FIG. 2 and to FIG. 5, the use of the cable management system 30 within the electronics assembly 10 will be described. In the preferred embodiment, cables may enter the electronics assembly 10 from the rear or from a side or both sides of the electronics assembly 10 or in any combination thereof. The cable management system 30 illustrated in FIG. 2 provides for handling cables that enter through two opposing sides of the electronics assembly and for handling cables that enter the rear of the electronics assembly in any combination thereof. It is noted that cable management system 30 may be configured for handling cables entering an electronics assembly from any opening in this electronic assembly 10 such that this functional aspects of the present invention are realized.

Referring to FIG. 4, and as discussed above, cables may enter through the opening 29 and be guided and supported by the cable support grooves 54 of the cable support tray 44. The combination of the cable support tray 44 and the cable guide plate 46 forms a plurality of continuous channels 27 for isolating individual cables or groups of cables. Cables may then pass from the rear of the electronics assembly 10 to the front of the electronics assembly 10 and be guided downwardly by the cable saddles 64 of the cable guide plate 46 thereby remaining organized and separated from each other. The cables may then continue downward and be captured by the horizontal cable capture trees 92. The cables preferably pass through passages 82 and enter the capturing regions 80 of the horizontal cable capture trees 92. As such, a large number of cables may be guided from the exterior of the electronics assembly 10 to the signal processing equipment 11 within the electronics assembly 10 in an organized manner. This allows for cables associated with a particular electronics card or component within the electronics assembly to remain together such that the cables may be later quickly and easily identified. For example, where a particular component within the electronics assembly would need to be replaced or serviced, the component including its associated cables could be quickly and easily removed without having to untangle a large number of cables from each other.

Cables may also enter the electronics assembly 10 from either side of door 14 through opening 28 in the door 14. Cables preferably pass through the opening 28 and then pass through a region 80 of a cable capture tree 52 of a vertical group 94. Referring to FIG. 5, the cables preferably pass through openings 82 and are captured within regions 80 of a capture tree 52 of the vertical group 94. Each cable capture tree 52 of the vertical group 94 is oriented at a predetermined angle as is illustrated in FIG. 5. This angle is preferably based upon the particular cables which are to be utilized. That is, the angle is dependent upon certain factors such as the general diameter of the cables and the stiffness of the cables and for fiber optic cables, a minimum bend radius. Preferably, this angle is determined empirically. The cables then are routed over cable support pins 48 such that they are directed to a capture tree 52 of the horizontal group 92. The cables may then pass through openings 82 and be captured within regions 80 of the horizontal group of cable capture trees 92. Preferably, individual capture trees 52 of the horizontal group 92 have a generally horizontal orientation as is shown in FIG. 5 such that the regions 80 direct cables generally downward. It is noted that the individual cable trees 52 of the horizontal group 92 may be oriented at an angle directing the cables in a predetermined direction. Preferably, the cables make a smooth transition from being generally horizontally oriented when entering opening 28 to being generally vertically oriented and directed to electronic components within the enclosure 12. Moreover, the cables are supported by the support pins 48 in making the transition from being horizontally oriented to vertically or otherwise directed.

In the preferred embodiment, a single cable or group of cables is assigned to a predetermined opening 80 in a predetermined cable capture tree 52. Preferably, a cable or group of cables is assigned to an opening 80 in a cable capture tree 52 of a vertical group 94 and is also assigned to the corresponding opening 80 in the corresponding cable capture tree 52 in a horizontal group 92. Preferably, the capture trees 52 are provided with indicia related to electronic components to provide for servicing and finding of cables for specific locations.

Support pins 48 are particularly useful when fiber-optic cables are used. Fiber-optic cables have a minimum allowable bend radius so as to prevent damage to the cables that would result in deteriorated signal transmission performance. The support pins 48 are preferably provided in predetermined positions that maintain industry standard minimum bend radiuses for fiber-optic cables. Further, the cable guide plate 46 preferably includes guidelines 62 for visually identifying the minimum allowable bend radius for a fiber-optic cable. This allows a technician installing and/or servicing cables within the cable management system 30 to visually verify that the fiber-optic cables do not exceed the minimum bend radius.

Cable guide pins 50 are provided to guide cables entering through the opening 28 and more particularly are provided to prevent cables from sagging downwardly and interfering with the door 14. That is, cable guide pins 50 prevent interference between the cables and the opening 28 in the door 14. As such, the door may be easily opened and closed without interfering with cables passing through the opening 28. As described above, it is contemplated that the opening 28 may additionally have a structure or mechanism (not shown) utilized for strain relief of the cables passing through the opening 28. For example, the opening 28 may have a clamp type structure for strain relief of the cables such that a portion of the clamp could be removed in order to open the door 14 without disturbing the cables. Further, the cable guide pins 50 provide guiding of cables that are guided by the cable saddles 64. That is, cables may pass over the cable saddling 64 and be directed generally vertically and be further guided by the cable guide pins 50.

It is noted that the door 14 of the electronics assembly 10 may have an opening 28 on one side panel of the door 14 or on both side panels of the door 14 or may have multiple openings on one or both side panels for introducing cables into electronics assembly 10. It is further contemplated that an opening or multiple openings may be provided in the top panel 35 of the door 14 for introducing cables.

The present invention is not limited to the above described preferred apparatus. More generally, the invention embraces guiding and supporting a large number of cables within an electronics assembly. Furthermore, it should be understood that, while particular embodiments of the invention have been discussed, this invention is not limited thereto as modifications may be made by those skilled in the art, particularly in light of the foregoing teachings. Accordingly, the appended claims contemplate coverage of any such modifications as incorporate the essential features of these improvements within the true spirit and scope of the invention.

What is claimed is:

1. A cable guide device for supporting a plurality of cables and guiding the cables as they are routed to electronic equipment, the cable guide device comprising a cable guide body having a substantially two-dimensional cable guide surface and a first cable guide system along a portion of the cable guide surface, the first cable guide system comprising a plurality of first cable guides spaced along the cable body in a first direction, the first cable guide system for guiding a plurality of cables over the substantially two-dimensional cable guide surface, said cable guide body further comprising a common cable support system including at least one cable capture element that extends from the cable guide body at least partially in a third dimension with respect to the two-dimensional cable guide surface for supporting at least one cable at a level spaced from the two-dimensional cable guide surface.

2. The cable guide device of claim 1, wherein the common cable support system includes at least one cable capture element that extends from the cable guide body at least partially in a third dimension with respect to the two-dimensional cable guide surface for supporting a plurality of cables at multiple levels from the two-dimensional cable guide surface.

3. The cable guide device of claim 2, wherein the first cable guides comprise grooves spaced in the first direction along the cable guide surface.

4. The cable guide device of claim 2, wherein the first cable guides comprise a plurality of cable capture elements arranged in the first direction and that extend from the two-dimensional cable guide surface at least in the third dimension for supporting a plurality of cables at multiple levels from the two-dimensional cable guide surface.

5. The cable guide device of claim 2, further comprising a second cable guide system comprising a plurality of second cable guides spaced along the cable body in a second direction that is different that the first direction.

6. The cable guide device of claim 5, wherein the cable capture element of the common cable support system is positioned to extend from the cable guide body so as to be able to guide cables from either of the first and second cable guide systems.

7. The cable guide device of claim 6, wherein the first cable guides are positioned with respect to the cable capture element of the common cable support system so as to support a plurality of cables along a substantially arcuate path.

8. The cable guide device of claim 7, wherein the second cable guides are positioned with respect to the cable capture element of the common cable support system so as to also support a plurality of cables along a substantially arcuate path.

9. The cable guide device of claim 8, wherein the first cable guides comprise grooves positioned along an edge of the cable guide body, the grooves defining a substantially arcuate guide path.

10. The cable guide device of claim 9, wherein the grooves of the first cable guide system are curved along an edge of the cable guide body so as to provide an arcuate guide path for supporting cables over about a 90° bend.

11. The cable guide device of claim 10, further comprising a cable support tray provided to extend from the grooves of the first cable guide system, the cable support tray further having support tray grooves running at least partially over a surface thereof, the support tray grooves being aligned with the first cable guide grooves.

12. The cable guide device of claim 8, wherein the second cable guides comprise a plurality of guide posts arranged in the second direction and provided to extend from the cable guide body at least partially in the third dimension with respect to the two-dimensional cable guide structure.

13. The cable guide device of claim 12, wherein the guide posts comprise cable capture elements in addition to the at least one cable capture element of the common cable support system.

14. The cable guide device of claim 13, further comprising a plurality of cable capture elements of the common cable support system.

15. The cable guide device of claim 14, wherein each cable capture elements comprises at least one rib that extends from the cable capture element to facilitate cable capture along the length of the cable capture element.

16. The cable guide device of claim 15, further comprising an end element extending from the rib so as to further facilitate cable capture thereby.

17. The cable guide device of claim 16, further comprising a plurality of ribs with end elements that are aligned with one another along the cable capture elements as a first set thereof and that extend from the cable capture elements to create a first plurality of cable capture regions between adjacent ribs, which cable capture regions are partially closed off by adjacent end elements.

18. The cable guide device of claim 17, further comprising a second set of plural ribs with end elements that are aligned with one another along the cable capture elements and that extend from the cable capture elements in a different radial direction that the first set to create a second plurality of cable capture regions between adjacent ribs, which cable capture regions are partially closed off by adjacent end elements.

19. The cable capture device of claim 18, wherein the first and second set of ribs are radially aligned at 180° from one another, and the cable capture elements of the second cable guide system are arranged with their respective ribs arranged at an angle to the second direction.

20. The cable capture device of claim 14, wherein the first direction is substantially perpendicular to the second direction and the common cable support system also extends along the cable guide body in substantially the first direction but space from the first cable guide system.

21. The cable capture device of claim 20, further comprising a plurality of cable support pins at intermediate locations along arcuate paths between the cable capture elements of the second cable guide system and the cable capture elements of the common cable support system.

22. The cable capture device of claim 21, wherein the second cable guide system is arranged along an edge of the cable guide body with its related common cable support system arranged in a substantially perpendicular direction to the second direction, the cable capture device further comprising another set of the second cable guide system arranged along a substantially parallel edge of the cable guide body and having another related common cable support system, so that cables can be directed through the cable capture device along the cable guide body from either edge having a second cable guide system through a common cable support system and through the first cable guide system through the common cable support system.

23. The cable capture device of claim 22, wherein the cable support tray is divided into plural sections of grooves to make up the first cable guide support system with each section substantially aligned with cable capture elements of a common cable support system.

24. An electronic equipment enclosure having at least a pair of spaced sidewalls and support structure operatively connecting the sidewalls and providing structure for supporting at least one electronic component within the enclosure, the enclosure further comprising a cable guide device operatively supported within the enclosure for supporting a plurality of cables and guiding the cables as they are routed to the electronic equipment, the cable guide device comprising a cable guide body having a first cable guide system and a second cable guide system, the first cable guide system comprising a plurality of first cable guides spaced along the cable body in a first direction, the second cable guide system comprising a plurality of second cable guides spaced along the cable body in a second direction that is different that the first direction, the first and second cable guide systems thereby creating a two-dimensional cable guide structure, said cable guide body further comprising a common cable support system including at least one cable capture element that extends from the cable guide body at least partially in a third dimension with respect to the two-dimensional cable guide structure for supporting a plurality of cables at multiple levels from the two-dimensional cable guide structure.

25. A cable guide device for supporting a plurality of cables and guiding the cables as they are routed to electronic equipment, the cable guide device comprising a cable guide body having a first cable guide system and a second cable guide system, the first cable guide system comprising a plurality of first cable guides spaced along the cable body in a first direction, the second cable guide system comprising a plurality of second cable guides spaced along the cable body in a second direction that is different that the first direction, the first and second cable guide systems thereby creating a two-dimensional cable guide structure, said cable guide body further comprising a common cable support system including at least one cable capture element that extends from the cable guide body at least partially in a third dimension with respect to the two-dimensional cable guide structure for supporting a plurality of cables at multiple levels from the two-dimensional cable guide structure.
